(19) United States
(12) Patent Application Publication
(10) Pub. No.: US 2019/0050449 A1
(43) Pub. Date: Feb. 14, 2019

(54) METHOD AND SYSTEM FOR CREATING INTELLIGENT CONTEXT AWARE INTERLINKED ZONES IN A MAP

(71) Applicant: MediaAgility Inc, Princeton, NJ (US)

(72) Inventors: Shishir Gokhale, Pune (IN); Deepak Garg, Pune (IN)

(73) Assignee: MediaAgility Inc, Princeton, NJ (US)

(21) Appl. No.: 16/033,205

(22) Filed: Jul. 12, 2018

Related U.S. Application Data
(60) Provisional application No. 62/531,368, filed on Jul. 12, 2017.

(51) Int. Cl. G06F 17/30; G06Q 10/06

(52) U.S. Cl. CPC G06F 17/30377; G06Q 10/067; G06F 17/30477; G06F 17/30241

(57) ABSTRACT

Disclosed are systems (100) and (600) and a method (200) of creating intelligent context aware interlinked zones in a map. More specifically the creation of intelligent context aware interlinked zones uses predefined context parameters and historical data. For an initial zoning of the map, the identified outer boundary of the map and a first subset of context parameters are used. The initial zoning is intelligently updated using the identified second subset of the context parameters and context aware interlinked zones for the map are created.

The present disclosure claims priority from the provisional U.S. patent application No. 62/531,368 filed on Jul. 12, 2017, and all the contents of the provisional application are included herein.

### FIELD OF THE INVENTION

The title relates to the field of creation of interlinked zones in a map. More specifically the evolution of interlinked zones in a map uses context aware data and historical data.

### BACKGROUND OF THE INVENTION

Various references available in prior art describe intelligent methods of evolving grids and areas for a map. U.S. Pat. No. 9,122,693 B2 teaches about drawing a bounded area (polygon of points) that defines the location where the user has been for a sustained period of time. Each of the boundary points is the center of a cluster of points that the user has been at. US 20130159207 describes identifying a location in a package and mail delivery system. It further describes dividing the Earth's surface into a grid system assigning the position of the location coordinate, and then further dividing the grid into increasingly smaller grid units until a precise identifier is determined for the input location coordinate. U.S. Pat. No. 8,731,823 talks about advanced map information delivery, processing and updating. This patent talks about the method of refreshing map tiles on a vehicle device based on new tiles that are sent by the server and storing them on the vehicle device. This describes GPS map tile updates for updated data on the server. U.S. Pat. No. 6,408,243 B1 is yet another example of a Service Delivery System. US 20160148268 teaches restricting the delivery of goods to within a defined delivery grid. U.S. Pat. No. 9,305,241 B2 teaches systems and methods for reducing a point cloud data set. According to aspects of U.S. Pat. No. 9,305,241 B2, a method includes receiving a point of a point cloud data set, the point having three-dimensional coordinates then the point's coordinates are mapped to a location to determine whether a different point's coordinates have already been mapped to the location and then the point is discarded when a different point's coordinates have been mapped to the location.

In view of the above prior art, there is a need to be able to identify dynamic zoning that could be obtained using various business rules and conditions. There is no mention of using a first subset of predefined context parameters to define an initial zoning and then using a second subset to dynamically redefine the zoning for a particular business condition. Secondly, there is no mention of redefining the zoning using intelligent methods including but not limited to artificial intelligence, machine learning based or statistics based models or any combination thereof. Thirdly, there is no mention of using historical data to redefining and re-zoning the map so as to reduce computation.

### SUMMARY OF THE INVENTION

The present disclosure describes systems and a method for creating intelligent context aware interlinked zones for a map using at least one selected from the set comprising a plurality of predefined context parameters and historical data. In an exemplary mode for the disclosure, for a given map, the creation of intelligent context aware interlinked zones in a map is done using various steps. This could be also be a system or/and also on a computer readable medium configured to implement the exemplary steps.

In an exemplary mode, an outer boundary of the map is identified and a plurality of predefined context parameters are obtained and stored. Then a first subset of context parameters and a second subset of context parameters are derived from the context parameters. An initial zoning for the map is executed using the outer boundary and the first subset of context parameters obtained.

As per yet another aspect of the disclosure, context aware interlinked zones for the map are generated using the second subset of context parameters obtained from the subset selection and the initial zoning obtained and the context aware interlinked zones for the map are stored.

As per one more aspect of the disclosure, historical data is also used to generate the context aware intelligent interlinked zones for the map. Historical data stores at least one selected from the set comprising the map, corresponding outer boundary of the map, the predefined set of context parameters, the first subset of context parameters, the second set of context parameters, the initial zoning of the map, the context aware interlinked zones of the map. Historical data may also include data from similar business applications and may reduce the computation otherwise required.

It is yet another aspect of the disclosure that the plurality of predefined context parameters comprises topography of the map and business parameters and the computation of correlations between the initial zoning of the map and the second subset of context parameters is done using methods selected from statistical methods, numerical methods, expert systems based methods, artificial intelligence based methods, machine learning methods and any combination thereof.

### BRIEF DESCRIPTION OF THE DRAWINGS

For a more complete understanding of the present invention and the advantages thereof, reference is now made to the following descriptions taken in connection with the accompanying drawings in which:

FIG. 1 describes a system 100 configured for creating intelligent context aware interlinked zones for a map;

FIG. 2 depicts a flow chart 200 for a method corresponding to the system 100, to create intelligent context aware interlinked zones for a map, in which one or more steps of the logic flow can be mapped to various system blocks of system 100 of FIG. 1;

FIGS. 3, 4 and 5 together depict an exemplary implementation of the method of flow chart 200 described in FIG. 2, creating intelligent context aware interlinked zones for a map, specifically for a supply chain example, wherein:

FIG. 3 depicts a schemata 300, wherein initial zoning is done for a map using a first subset of context parameters;

FIG. 4 depicts a schemata 400, wherein the intermediate updated zoning is performed using second subset of context parameters, and

FIG. 5 depicts a schemata 500, wherein the final updated zoning is performed using the second subset of context parameters; and

FIG. 6 depicts a system 600 with a memory and a processor configured to create intelligent context aware interlinked zones for a map, wherein the memory and the processor are functionally coupled to each other.

### DETAILED DESCRIPTION

The present disclosure describes a system and method for creating intelligent context aware interlinked zones for a map using at least one selected from the set comprising a plurality of predefined context parameters and historical data.

The system could also be a computer readable medium, functionally coupled to a memory, where the computer readable medium is configured to implement the exemplary steps of the method. The system can be implemented as a stand-alone solution, as a Software-as-a-Service (SaaS) model or a cloud solution or any combination thereof.

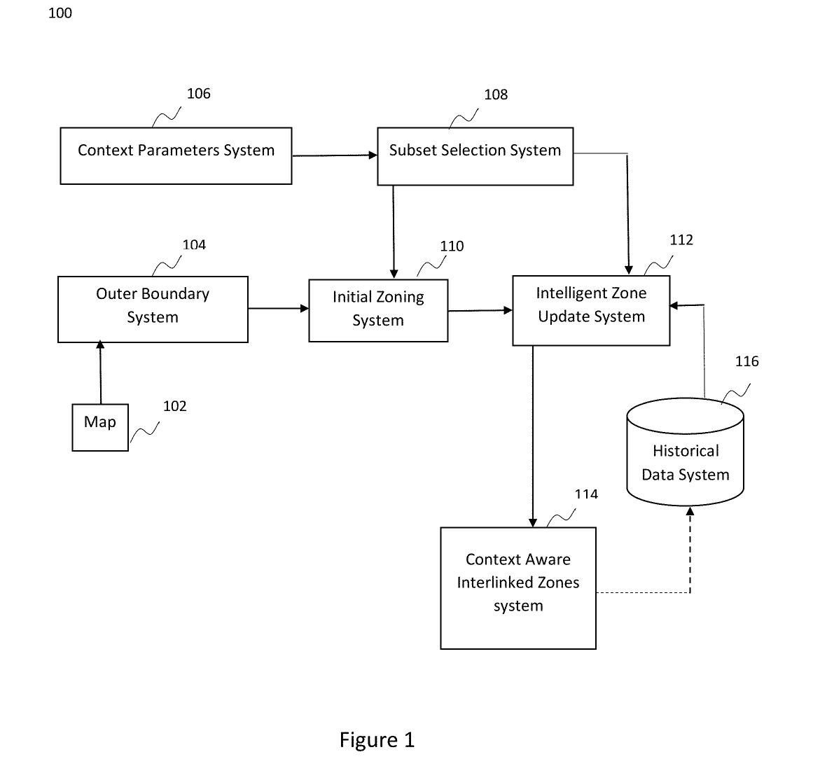

FIG. 1 describes a system (100) for creating intelligent context aware interlinked zones in a map (102). The system (100) also includes an outer boundary system (104) to identify an outer boundary of the map (102) and further includes a context parameters system (106) associated with the map (102). The context parameters system (106) stores a plurality of predefined context parameters. In an exemplary manner plurality of predefined context parameters includes topography of the map (102) and business parameters. In turn the business parameters could include but are not limited to: revenue distribution, sales distribution, consumer density, sales per capita, revenue per capita, service center density, personnel density, and similar parameters. Topographical parameters may include terrain, postal zipcodes, pre-identified regions, and similar parameters.

The system (100) also includes a subset selection system (108) used for identifying a first subset of context parameters and a second subset of context parameters, wherein the subset selection system (108) derives from the context parameters system (106). The system (100) further includes an initial zoning system (110) to create an initial zoning for the map (102) using the outer boundary system (104) and the first subset of context parameters obtained from the subset selection system (108). The initial zoning is done within the outer boundary identified and also in an exemplary fashion is interconnected and convex. In yet another exemplary mode, the interlinked initial zoning may be overlapping and convex.

The system (100) also then includes an intelligent zone update system (112) to generate context aware interlinked zones for the map (102) using the second subset of context parameters obtained from the subset selection system (108) and the initial zoning obtained from the initial zoning system (110). the intelligent zone system (112) computes correlations between the initial zoning of the map (102) and the second subset of context parameters using methods selected from statistical methods, numerical methods, expert systems based methods, artificial intelligence based methods, machine learning methods and any combination thereof.

The system (100) also includes a context aware interlinked zones system (114) for storing the context aware interlinked zones for the map (102) derived from the intelligent zone update system (112).

The system (100) also includes a historical data system (116) storing at least one selected from the set comprising the map (102), corresponding outer boundary of the map (102), the predefined set of context parameters, the first subset of context parameters, the second set of context parameters, the initial zoning of the map (102), the context aware interlinked zones of the map (102), wherein the historical data system (116) is functionally coupled to the intelligent zone update system (112).

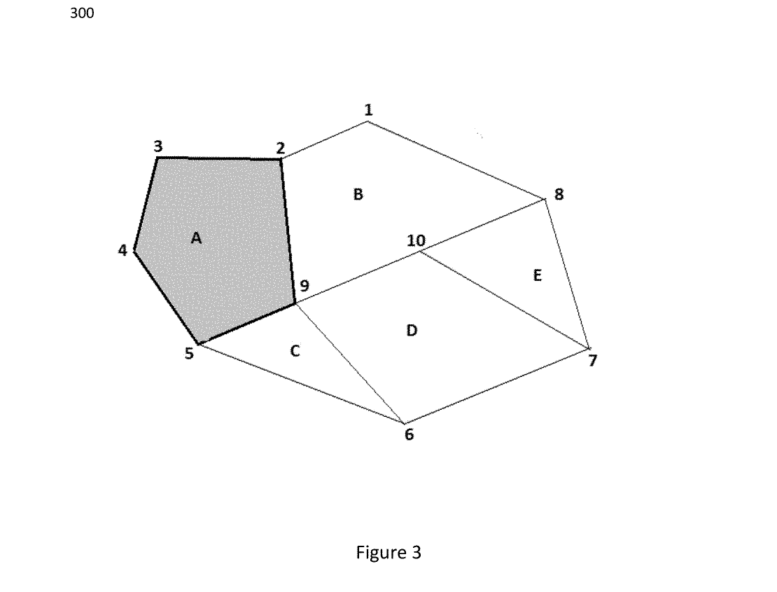

The historical data system (116) may in an exemplary manner include data about similar business problem to be solved. This is explained more in an exemplary embodiment with respect to FIGS. 3, 4 and 5.

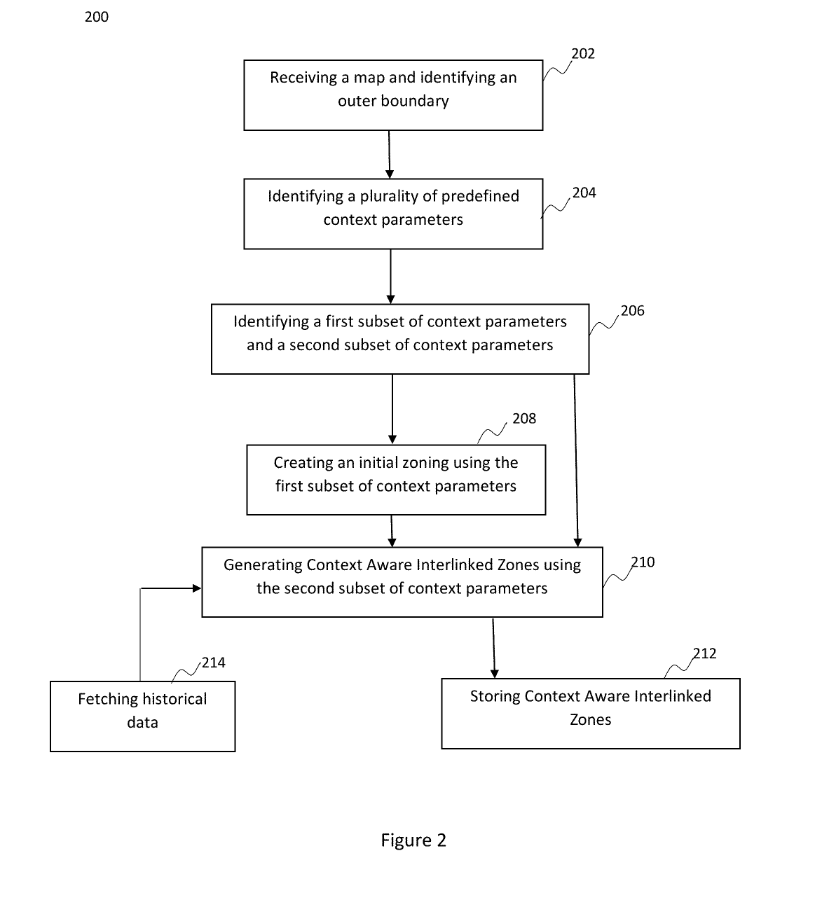

We now refer to FIG. 2 which describes a flowchart for various steps of a method (200) to create intelligent context aware interlinked zones for a map, in which various one or more steps of the logic flow can be mapped to various system blocks of system (100) of FIG. 1. Thus this method (200) is consistent with the system (100) described in FIG. 1, and is explained in conjunction with components of the system (100).

Step (202) describes receiving the map (102) and identifying an outer boundary of the map (102). Step (204) describes identifying a plurality of predefined context parameters associated with the map (102), wherein the identifying takes place in the context parameters system (106). The plurality of predefined context parameters identified in step (204) may include, in an exemplary manner, topography of the map (102) and business parameters. In turn the business parameters in exemplary manner could include but are not limited to: revenue distribution, sales distribution, consumer density, sales per capita, revenue per capita, service center density, personnel density, and similar parameters. Topographical parameters may include terrain, postal zipcodes, pre-identified regions, and similar parameters.

Step (206) essentially is about partitioning the predefined context parameters into a first subset of context parameters and a second subset of context parameters, wherein the first subset of context parameters and the second subset of context parameters are subsets from the plurality of the predefined context parameters identified in the context parameters system (106). The initial zoning for the map (102) is depicted in step (208) using the outer boundary of the map (102) and the first subset of context parameters obtained from the subset selection system (108) obtained in step (206).

Step (210) then shows generating context aware interlinked zones for the map (102) using the second subset of context parameters obtained from the subset selection system (108) and the initial zoning obtained in step (208) from the initial zoning system (110). The step (210) of generating context aware interlinked zones for the map (102) uses correlations between the initial zoning of the map (102) and the second subset of context parameters using methods selected from statistical methods, numerical methods, expert systems based methods, artificial intelligence based methods, machine learning methods and any combination thereof.

Step (212) then shows storing the context aware interlinked zones for the map (102) derived from the intelligent zone update system (112).

Step (214) shows fetching historical data from a historical data system (116) storing at least one selected from the set comprising the map (102), corresponding outer boundary of the map (102), the plurality of predefined context parameters, the first subset of context parameters, the second set of context parameters, the initial zoning of the map (102), and the context aware interlinked zones of the map (102).

### Example Embodiment

FIGS. 3, 4 and 5 together depict an exemplary implementation of the method of flow chart 200 described in FIG. 2, creating intelligent context aware interlinked zones for a map, specifically for a supply chain example, wherein:

FIG. 3 depicts a schemata 300, wherein initial zoning is done for a map using a first subset of context parameters. As an exemplary illustration, FIG. 3 depicts the outer boundary of a map shown by points 1-2-3-4-5-6-7-8. Initial zoning has been done by identifying points 9 and 10 within this map, thus creating zones A, B, C, D and E. Initial zoning could be based on geographical representation of the map boundary defined by 1-8. As an illustration, zones A and B will be discussed. Points 9 and 10 may correspond to initial zones created using road boundaries within the outer boundary 1-8.

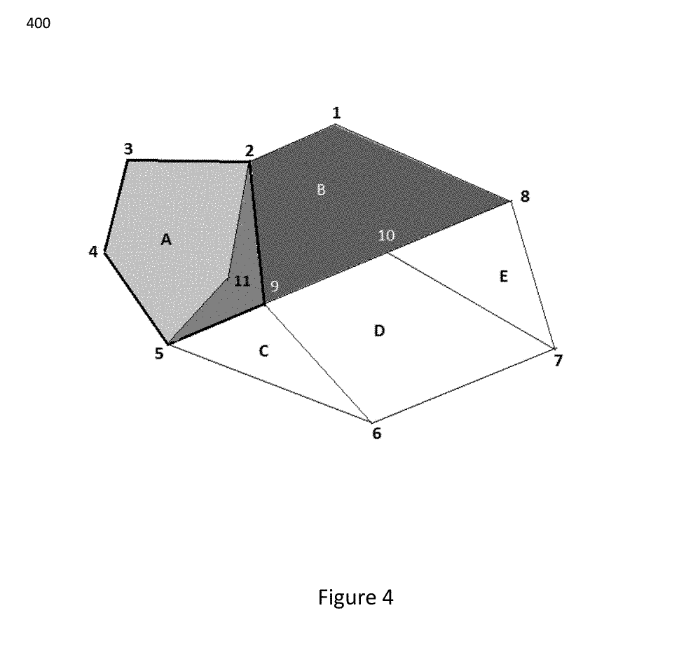

FIG. 4 depicts a schemata 400, wherein the intermediate updated zoning is performed using second subset of context parameters. As an illustration of food industry, zone A defined in FIG. 3 by points 2-3-4-5-9-2 has 300 customers, even though area-wise this zone is smaller than zone B defined by points 2-9-10-8-1-2. Zone B, though bigger in area, is sparsely populated and has only 200 customers. For food industry to serve its customers better so that the resources (serving personnel, transportation means and time required) are optimized, it is now desirable to re-zone using a point 11.

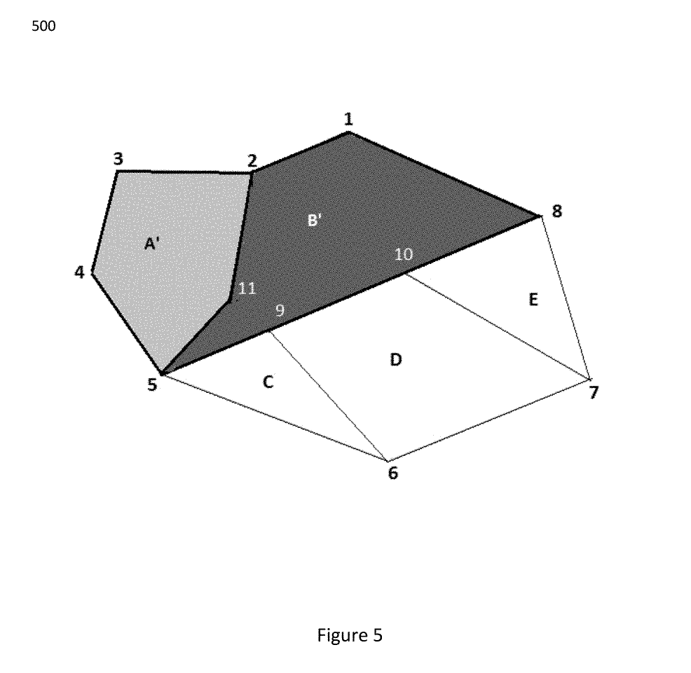

FIG. 5 depicts a schemata 500, wherein the final updated zoning is performed using the second subset of context parameters

In FIG. 5, new zone A′, is defined points 2-3-4-5-11-2, and has even smaller area but has 250 customers. New zone B′, now defined by points 2-11-5-9-10-8-1-2, has bigger area but now accommodates 250 customers. With A′ and B′, the food company is now able to re-distribute its resources making its operations smoother.

As far as the historical data system (116) of FIG. 1 and the step (214) of FIG. 2 are concerned, the example one could consider is that of supply-chain of some other commodity—say stationery or apparel items, being delivered in the same area bounded by 1-8 of FIG. 3, FIG. 4 and FIG. 5. If the second subset of context parameters includes, in an exemplary manner, customer density for apparel industry, one can still use this data to partition A of FIG. 3 into A′ of FIG. 5 based on the historical data of apparel industry but now applied to food or stationery distribution.

It is important to note that whether the supply-chain is that of a commodity of a service, the principle will apply similarly and historical data system (116) of FIG. 1 or step (214) of FIG. 2, will still add value.

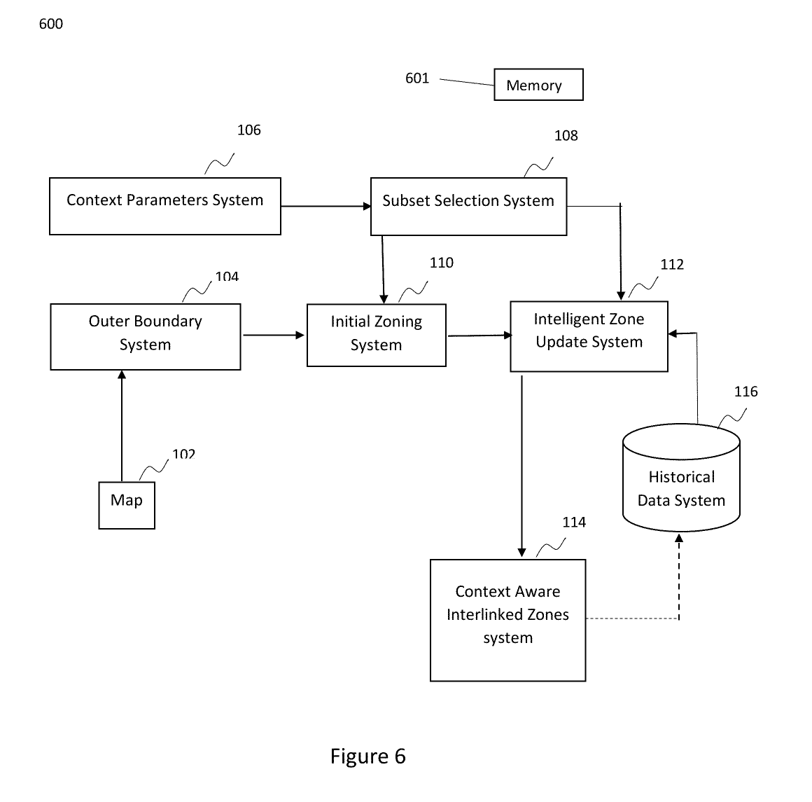

FIG. 6 depicts a system (600) for creating intelligent context aware interlinked zones in a map (102), wherein the system (600) includes a memory (601) and a processor, further wherein the memory (601) and the processor are functionally coupled to each other. The system (600) also further includes an outer boundary system (104) to identify an outer boundary of the map (102) and further includes a context parameters system (106) associated with the map (102). The context parameters system (106) stores a plurality of predefined context parameters. In an exemplary manner plurality of predefined context parameters includes topography of the map (102) and business parameters. In turn the business parameters could include but are not limited to: revenue distribution, sales distribution, consumer density, sales per capita, revenue per capita, service center density, personnel density, and similar parameters. Topographical parameters may include terrain, postal zipcodes, pre-identified regions, and similar parameters.

The system (600) also includes a subset selection system (108) used for identifying a first subset of context parameters and a second subset of context parameters, wherein the subset selection system (108) derives from the context parameters system (106). The system (600) further includes an initial zoning system (110) to create an initial zoning for the map (102) using the outer boundary system (104) and the first subset of context parameters obtained from the subset selection system (108). The initial zoning is done within the outer boundary identified and also in an exemplary fashion is interconnected and convex. In yet another exemplary mode, the interlinked initial zoning may be overlapping and convex.

The system (600) also then includes an intelligent zone update system (112) to generate context aware interlinked zones for the map (102) using the second subset of context parameters obtained from the subset selection system (108) and the initial zoning obtained from the initial zoning system (110). The intelligent zone update system (112) is functionally coupled to the processor. the intelligent zone update system (112) computes correlations between the initial zoning of the map (102) and the second subset of context parameters using methods selected from statistical methods, numerical methods, expert systems based methods, artificial intelligence based methods, machine learning methods and any combination thereof.

The system (600) also includes a context aware interlinked zones system (114) for storing the context aware interlinked zones for the map (102) derived from the intelligent zone update system (112).

The system (600) also includes a historical data system (116) storing at least one selected from the set comprising the map (102), corresponding outer boundary of the map (102), the predefined set of context parameters, the first subset of context parameters, the second set of context parameters, the initial zoning of the map (102), the context aware interlinked zones of the map (102), wherein the historical data system (116) is functionally coupled to the intelligent zone update system (112).

Thus, the systems (100) and (600) and the method (200) in accordance with the present disclosure are deployable across a plurality of platforms using heterogeneous server and storage farms spread across geographies for better availability and high response time.

The systems (100) and (600) and the method (200) are deployable using multiple hardware and integration options, such as, for example, cloud infrastructure, standalone solutions mounted on mobile hardware devices, third-party platforms and system solutions etc. and is advantageously facilitated to be validated using biometric and electronic verifications like e-KYC (Know Your Customer).

There are several advantages of the system and method of creating intelligent context aware interlinked zones for a map, proposed in the disclosure. One advantage is that the system and method include various context aware inputs to draw and update the interlinked zones in a map. Context aware inputs increase the efficiency and reliability of drawing and re-drawing grids.

Yet another advantage is that the use of historical data reduces computation and draws upon optimal designs already created for similar business purposes.

We claim:

1. A system (100) for creating intelligent context aware interlinked zones in a map (102), the system (100) comprising:
An outer boundary system (104) to identify an outer boundary of the map (102);
a context parameters system (106) associated with the map (102), the context parameters system (106) storing a plurality of predefined context parameters;
a subset selection system (108) identifying a first subset of context parameters and a second subset of context parameters, wherein the subset selection system (108) derives from the context parameters system (106);
an initial zoning system (110) to create an initial zoning for the map (102) using the outer boundary system (104) and the first subset of context parameters obtained from the subset selection system (108);
an intelligent zone update system (112) to generate context aware interlinked zones for the map (102) using the second subset of context parameters obtained from the subset selection system (108) and the initial zoning obtained from the initial zoning system (110); and
a context aware interlinked zones system (114) for storing the context aware interlinked zones for the map (102) derived from the intelligent zone update system (112).

2. The system (100) as claimed in claim 1, further comprising:
a historical data system (116) storing at least one selected from the set comprising the map (102), corresponding outer boundary of the map (102), the predefined set of context parameters, the first subset of context parameters, the second set of context parameters, the initial zoning of the map (102), the context aware interlinked zones of the map (102), wherein the historical data system (116) is functionally coupled to the intelligent zone update system (112).

3. The system (100) as claimed in claim 2, wherein:
the plurality of predefined context parameters comprises topography of the map (102) and business parameters; and
wherein the intelligent zone system (112) computes correlations between the initial zoning of the map (102) and the second subset of context parameters using methods selected from statistical methods, numerical methods, expert systems based methods, artificial intelligence based methods, machine learning methods and any combination thereof.

4. A method (200) for creating intelligent context aware interlinked zones in a map (102), the method (200) comprising the steps of:
receiving the map (102) and identifying an outer boundary of the map (102);
identifying a plurality of predefined context parameters associated with the map (102), wherein the identifying takes place in the context parameters system (106);
identifying a first subset of context parameters and a second subset of context parameters, wherein the first subset of context parameters and the second subset of context parameters are subsets from the plurality of the predefined context parameters identified in the context parameters system (106);
creating an initial zoning for the map (102) using the outer boundary of the map (102) and the first subset of context parameters obtained from the subset selection system (108);
generating context aware interlinked zones for the map (102) using the second subset of context parameters obtained from the subset selection system (108) and the initial zoning obtained from the initial zoning system (110); and
storing the context aware interlinked zones for the map (102) derived from the intelligent zone update system (112).

5. The method (200) as claimed in claim 4, further comprising:
fetching historical data from a historical data system (116) storing at least one selected from the set comprising the map (102), corresponding outer boundary of the map (102), the plurality of predefined context parameters, the first subset of context parameters, the second set of context parameters, the initial zoning of the map (102), and the context aware interlinked zones of the map (102).

6. The method (200) as claimed in claim 5, wherein:
the plurality of predefined context parameters comprises:
topography of the map (102); and
business parameters including but not limited to revenue, consumer density, revenue per capita, sales per capita, service center density and personnel density.

7. The method (200) as claimed in claim 5, wherein:
the step of generating context aware interlinked zones for the map (102) uses correlations between the initial zoning of the map (102) and the second subset of context parameters using methods selected from statistical methods, numerical methods, expert systems based methods, artificial intelligence based methods, machine learning methods and any combination thereof.

8. A system (600) for creating intelligent context aware interlinked zones in a map (102), the system (600) comprising at least a processor and a memory (601), wherein the memory (601) and the processor are functionally coupled to each other, the system (600) further comprising:
An outer boundary system (104) to identify an outer boundary of the map (102);
a context parameters system (106) associated with the map (102), the context parameters system (106) storing a plurality of predefined context parameters;
a subset selection system (108) identifying a first subset of context parameters and a second subset of context parameters, wherein the subset selection system (108) derives from the context parameters system (106);
an initial zoning system (110) to create an initial zoning for the map (102) using the outer boundary system (104) and the first subset of context parameters obtained from the subset selection system (108);
an intelligent zone update system (112) to generate context aware interlinked zones for the map (102) using the second subset of context parameters obtained from the subset selection system (108) and the initial zoning obtained from the initial zoning system (110), wherein the intelligent zone update system (112) is functionally coupled to the processor; and
a context aware interlinked zones system (114) for storing the context aware interlinked zones for the map (102) derived from the intelligent zone update system (112).

9. The system (600) as claimed in claim 8, further comprising:
a historical data system (116) storing at least one selected from the set comprising the map (102), corresponding outer boundary of the map (102), the predefined set of context parameters, the first subset of context parameters, the second set of context parameters, the initial zoning of the map (102), and the context aware interlinked zones of the map (102), wherein the historical data system (116) is functionally coupled to the intelligent zone update system (112).

10. The system (600) as claimed in claim 9, wherein:
the plurality of predefined context parameters comprises topography of the map (102) and business parameters; and
wherein the intelligent zone system (112) computes correlations between the initial zoning of the map (102) and the second subset of context parameters using methods selected from statistical methods, numerical methods, expert systems based methods, artificial intelligence based methods, machine learning methods and any combination thereof.
